(19) United States
(12) Patent Application Publication
(10) Pub. No.: US 2023/0328296 A1
(43) Pub. Date: Oct. 12, 2023

(54) COMPUTER-READABLE STORAGE MEDIUM, TERMINAL, AND SERVER

(71) Applicant: 17LIVE Japan Inc., Tokyo (JP)

(72) Inventor: Mizuki FUJIWARA, Tokyo (JP)

(21) Appl. No.: 17/894,829

(22) Filed: Aug. 24, 2022

(30) Foreign Application Priority Data
Apr. 11, 2022 (JP) 2022-065440

(51) Int. Cl. H04N 21/2187; H04N 21/2543; H04N 21/262; A63F 9/18

(52) U.S. Cl. CPC H04N 21/2187; H04N 21/25435; H04N 21/26225; A63F 9/181

(57) ABSTRACT

A computer-readable tangible non-transitory storage medium storing a program for causing a terminal of a viewer to: receive, from a server over a network, a video data related to a live-stream in which a distributor, the viewer, and other viewers participate; accept input of normal information by the viewer during the live-stream, the normal information being viewable by the distributor and the other viewers; and accept input of exclusive information by the viewer during the live-stream, the exclusive information being information that is transmitted to a terminal of the distributor on condition that the viewer pays or consents to pay a price and that is not viewable by the other viewers.

### CROSS-REFERENCE TO RELATED APPLICATIONS

This application is based on and claims the benefit of priority from Japanese Patent Application Serial No. 2022-65440 (filed on Apr. 11, 2022), the contents of which are hereby incorporated by reference in its entirety.

### TECHNICAL FIELD

The present disclosure relates to a terminal, a server, and a non-transitory computer-readable storage medium storing a program.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video distribution services also become popular as storage costs were reduced. And nowadays, with the sophistication of smartphones and further improvements in network speed as typified by 5G, services that enable real-time communication through video, especially live-stream services, are gaining recognition. The number of users of live-stream services is expanding, especially among young people, as such services allow people to share fun moments even when they are in the separate locations from each other.

Fortune telling has been provided as a face-to-face service. A fortune-teller and a customer sit facing each other to converse, and the fortune-teller tells customer's fortune. For example, “Cave's face-to-face fortune-telling live streaming service, SENSEN, pre-open on March 15,” Cave Co., Ltd., URL:https://prtimes.jp/main/html/rd/p/000000928.000001290.html, describes an attempt to provide the fortune-telling through live streaming. Due to the recent COVID-19 pandemic, there has been increasing demand for live-streaming fortune telling and viewing such a live-stream.

Dialog with a customer is one of the most important element in fortune-telling, and live-streaming provides interactive communication between a streamer and viewers, so there is a high affinity between the fortune-telling and the live-streaming. Therefore, demand for fortune-telling live streaming is expected to grow in the future. However, it is not easy for a fortune-telling streamer to earn rewards from his/her fortune-telling in a conventional live streaming in which multiple viewers participate.

### SUMMARY

In view of above, one object of the disclosure is to provide a technology that can facilitate fortune-telling streamers to earn rewards for fortune-telling through live streaming.

One aspect of the disclosure relates to a non-transitory computer-readable storage medium storing a program. The program causes a terminal to: receive, from a server over a network, a video data related to a live-stream in which a distributor, the viewer, and other viewers participate; accept input of normal information by the viewer during the live-stream, the normal information being viewable by the distributor and the other viewers; and accept input of exclusive information by the viewer during the live-stream, the exclusive information being information that is transmitted to a terminal of the distributor on condition that the viewer pays or consents to pay a price and that is not viewable by the other viewers.

Another aspect of the disclosure relates to a server. The server includes: a relay unit relaying video data from a terminal of a distributor to a terminal of a viewer, the video data being related to a live-stream in which the distributor, the viewer, and other viewers participate; a reception unit receiving normal information inputted by the viewer from a terminal of the viewer during the live-stream; a transmission unit transmitting the received normal information to a terminal of the distributor and terminals of the other viewers; and a transmission unit transmitting exclusive information inputted by the viewer to the terminal of the distributor when the viewer pays or consents to pay a price, the exclusive information being not transmitted to the terminals of the other viewers.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### ADVANTAGEOUS EFFECTS

According to the aspects of the disclosure, it is possible to facilitate fortune-telling streamers to earn rewards from their fortune-telling in live streaming.

### BRIEF DESCRIPTION OF THE DRAWINGS

FIG. 1 schematically illustrates a configuration of a live-streaming system in one embodiment.

FIG. 2 is a block diagram showing functions and configuration of a user terminal of FIG. 1.

FIG. 3 is a data structure diagram showing an example of a template DB in FIG. 2.

FIG. 4 is a block diagram showing functions and configuration of a server of FIG. 1.

FIG. 5 is a data structure diagram of an example of a stream DB in FIG. 4.

FIG. 6 is a data structure diagram showing an example of a user DB in FIG. 4.

FIG. 7 is a data structure diagram showing an example of a gift DB in FIG. 4.

FIG. 8 is a data structure diagram showing an example of a price setting DB in FIG. 4.

FIG. 9 is a flowchart of a series of steps related to the use of paid DM in a live streaming system.

FIG. 10 is a representative screen image of a live streaming selection screen displayed on a display of a viewer's user terminal.

FIG. 11 is a representative screen image of a live streaming room screen displayed on the display of the viewer's user terminal.

FIG. 12 is a representative screen image of a live streaming room screen on which a character count inquiry region is superimposed on the display of the viewer's user terminal.

FIG. 13 is a representative screen image of a live streaming room screen on which a template use inquiry region is imposed on the display of the viewer's user terminal.

FIG. 14 is a representative screen image of a live streaming room screen on which a paid DM input accepting region is superimposed on the display of the viewer's user terminal.

FIG. 15 is a representative screen image of a live streaming room screen on which a template registration region is superimposed on the display of the viewer's user terminal.

FIG. 16 is a block diagram showing an example of a hardware configuration of an information processing device according to the embodiment.

FIG. 17 is a representative screen image of a live streaming room screen of a modification example displayed on the display of the viewer's user terminal.

FIG. 18 is a representative screen image of a live streaming room screen displayed on the display of a user terminal of a viewer who sent a secret comment.

### DESCRIPTION OF EXAMPLE EMBODIMENTS

Like elements, components, processes, and signals throughout the Figures are labeled with same or similar designations and numbering, and the description for the like elements will not be hereunder repeated. For purposes of clarity and brevity, some of the components that are less related and thus not described are not shown in Figures.

In a live streaming system of one embodiment, a distributor provides a fortune telling to viewers in his/her live-stream. The system provides a means of allowing a specific viewer to give his/her information to the distributor without being known to other viewers while many other viewers are watching the same fortune-telling live stream. Moreover, since this means is provided to viewers for a fee, it also functions as a means for the fortune-telling distributor to receive a reward. This provides a system of fortune-telling live streaming in which viewers can safely give their own information to the distributor, and the distributor can easily receive a reward.

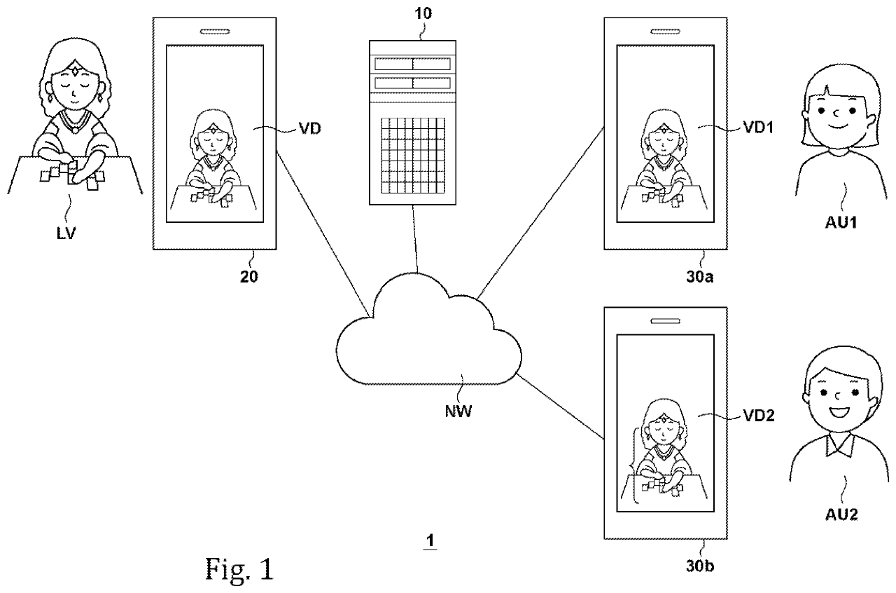

FIG. 1 schematically illustrates a configuration of a live-streaming system 1 according one embodiment of the disclosure. The live-streaming system 1 provides an interactive live-stream service that allows a distributor LV (also referred to as a liver or streamer) and a viewer AU (also referred to as audience) (AU1, AU2 . . . ) to communicate in real time. As shown in FIG. 1, the live-streaming system 1 includes a server 10, a user terminal 20 on the distributor side, and user terminals 30 (30a, 30b . . . ) on the audience side. The distributor and viewers may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminal 30 are interconnected so as to be able to communicate with each other over the various wired or wireless network NW.

The live-streaming system 1 involves the distributor LV, the viewers AU, and an administrator (not shown) who manages the server 10. The distributor LV is a person who broadcasts contents in real time by recording the contents with his/her user terminal 20 and uploading them directly to the server 1. Examples of the contents may include the distributor's own songs, talks, performances, fortune-telling, gameplays, and any other contents. In the embodiment, the distributor LV tells viewer AU's fortune in a live stream. Such a live stream may be categorized as a fortune-telling genre. The distributor LV may or may not be a fortune teller. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or ask fortune-telling via the user terminal 30, the distributor LV who is delivering the content responds to such a comment, cheer, or request and such response is transmitted to the viewer AU via video and/or audio, thereby establishing an interactive communication.

The term “live-streaming” may mean a mode of data transmission that allows a content recorded at the user terminal 20 of the distributor LV to be played and viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay even with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 and 30, and audio data generated using an audio input function of the user terminals 20 and 30. Video data is reproduced in the user terminals 20 and 30, so that the users can view contents. In this embodiment, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 1, and the video data received and reproduced at the viewer's user terminal are all the same video data.

In the example in FIG. 1, the distributor LV is live-streaming his/her fortune telling. The user terminal 20 of the distributor LV generates video data by recording images and sounds of the distributor LV telling fortune, and the generated data is transmitted to the server 10 over the network NW. At the same time, the user terminal 20 displays a recorded video image VD of the distributor LV on the display of the user terminal 20 to allow the distributor LV to check the live stream currently performed.

The user terminals 30a and 30b of the viewers AU1 and AU2 respectively, who have requested the platform to view the live-stream of the distributor LV, receive video data related to the live-stream (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the fortune told by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond the comment, the video and sound of the talk are displayed on the user terminals 30a and 30b of the viewers AU1 and AU2, respectively. This interactive action is recognized as establishment of a conversation between the distributor LV and the viewer AU1. In this way, the live-streaming system 1 realizes the live-streaming that enables the interactive communication, not one-way communication.

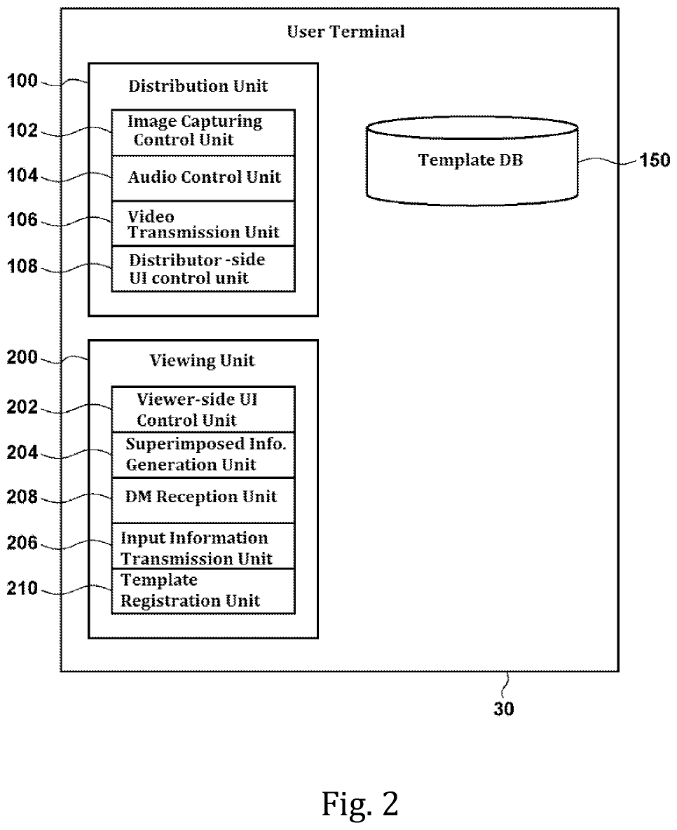

FIG. 2 is a block diagram showing functions and configuration of the user terminal 30 of FIG. 1. The user terminal 20 has the same functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks realized by cooperative operation between these elements. Therefore, it is understood by those skilled in the art that these functional blocks can be realized in various forms by combining hardware and software.

The distributor LV and the viewers AU download and install a live-streaming application program (hereinafter referred to as a live-streaming application) according to the embodiment to the user terminals 20 and 30 from a download site over the network NW. Alternatively, the live-streaming application may be pre-installed on the user terminals 20 and 30. When the live-streaming application is executed on the user terminals 20 and 30, the user terminals 20 and 30 communicate with the server 10 over the network NW to implement various functions. Hereinafter, the functions implemented by the user terminals 20 and 30 (processors such as CPUs) in which the live-streaming application is run will be described as functions of the user terminals 20 and 30. These functions are realized in practice by the live-streaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 that generates video data in which the user's image and sound are recorded and provides the video data to the server 10, a viewing unit 200 to which the video data is provided from the server 10 to reproduce the video data, and a template DB 150. The user activates the distribution unit 100 when the user performs live-streaming, and activates the viewing unit 200 when the user views a video. The user terminal in which the distribution unit 100 is activated is the distributor's terminal, i.e., the user terminal that generates the video data, and the user terminal in which the viewing unit 200 is activated is the viewer's terminal, i.e., the user terminal is which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI for the distributor. The distribution-side UI control unit 108 is connected to a display (not shown in FIG. 2), and displays a video on the display by reproducing the video data that is to be transmitted by the video transmission unit 106. The distribution-side UI control unit 108 displays an operation object or an instruction-accepting object on the display, and accepts inputs from the distributor who taps on the object.

The viewing unit 200 includes a viewer-side UI control unit 202, a superimposed information generation unit 204, an input information transmission unit 206, a DM reception unit 208, and a template registration unit 210. The viewing unit 200 receives, from the server 10 over the network NW, the video data related to the live-stream in which the distributor, the viewer who is the user of the user terminal 30, and other viewers participate. The viewer-side UI control unit 202 controls the UI for the viewers. The viewing-side UI control unit 202 is connected to a display and speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and information obtained from the server 10. The input information transmission unit 206 transmits the user input obtained by the viewer-side UI control unit 202 to the server 10 over the network NW.

The viewer-side UI control unit 202 accepts input of comments by a viewer via the input means during the live-stream. As described above, those comments are normal information that can be viewed not only by the viewer who entered the comment and the distributor, but also by other viewers participating in the live-stream. The comments can be entered and sent free of charge, i.e., without requiring payment.

The DM reception unit 208 accepts a paid DM (direct message) input from a viewer(s) to the distributor during a live-stream. The paid DM is a direct message that is inputted and transmitted on condition of payment by the viewer. This payment is made during the live-stream. The DM is a message that can be viewed only by the recipient distributor in addition to the viewer who entered the message. The DM is exclusive information that can be viewed only by the viewer who entered the message and the distributor, and in particular, other viewers of the live-stream cannot view the DM. The technology to realize the DM itself is well known and is not described herein. The function of the DM reception unit 208 will be later described.

The template registration unit 210 registers a pre-inputted text for the paid DM inputted by a viewer as a template in the template DB 150. The template registration unit 210 displays a template registration screen on the user terminal 30 for accepting text input before the viewer participates in the fortune-telling live stream. The template registration unit 210 registers the text inputted on the template registration screen as the template in the template DB 150.

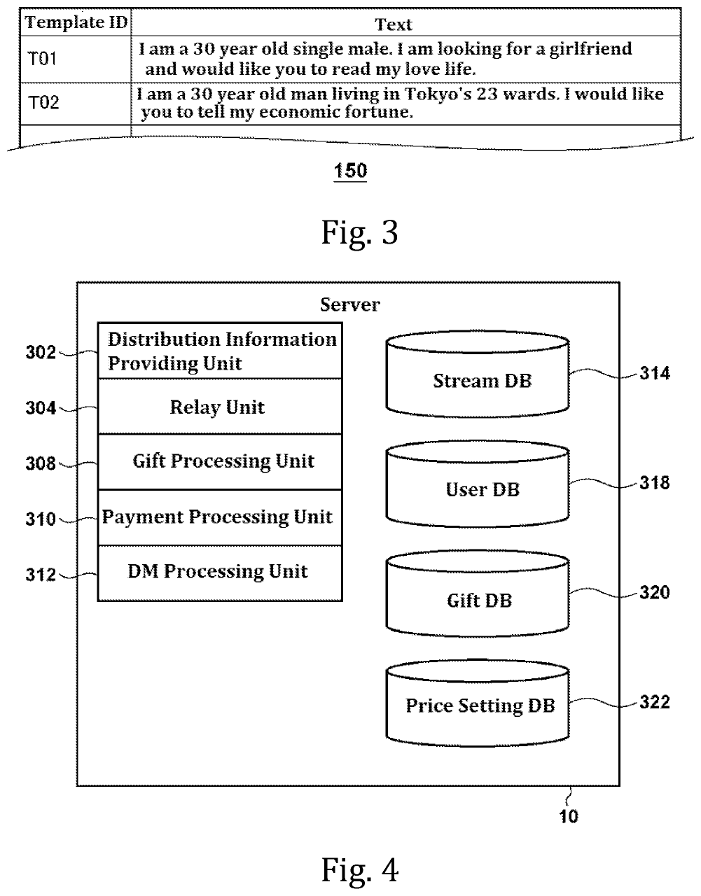

FIG. 3 is a data structure diagram showing an example of the template DB 150 in FIG. 2. The template DB 150 stores a template ID for identifying a template and the text of the template in association with each other. The text may include information that should be provided for the distributor to tell the viewer's fortune, and may include information such as gender, age, and address, for example. The text may also include a desired fortune-telling subject (financial luck, love luck, etc.) and the type of fortune-telling (tarot cards, astrology, etc.).

FIG. 4 is a block diagram showing functions and configuration of the server of FIG. 1. The server 10 includes a distribution information providing unit 302, a relay unit 304, a gift processing unit 308, a payment processing unit 310, a DM processing unit 312, a stream DB 314, a user DB 318, a gift DB 322, and a price setting DB 322.

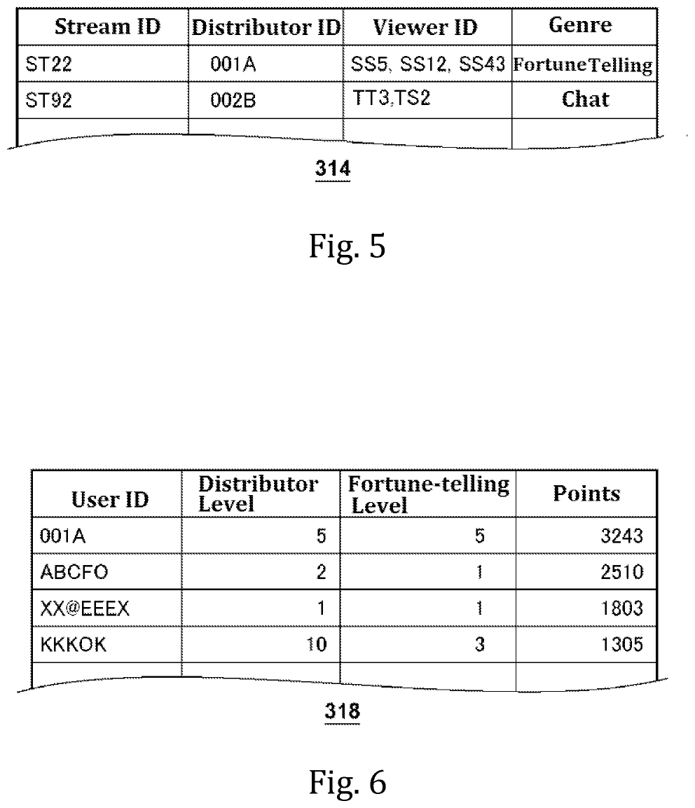

FIG. 5 is a data structure diagram of an example of the stream DB 314 of FIG. 4. The stream DB 314 holds information regarding a live-stream currently taking place. The stream DB 314 stores a stream ID for identifying a live-stream on a live-streaming platform provided by the live-streaming system 1, a distributor ID, which is a user ID for identifying the distributor who provides the live-stream, a viewer ID, which is a user ID for identifying a viewer of the live-stream, and a genre of the live-stream, in association with each other. In the live-streaming platform provided by the live-streaming system 1 of the embodiment, when a user live-streams, the user becomes a distributor, and when the same user views a live-stream broadcast by another user, the user also becomes a viewer. Therefore, the distinction between a distributor and a viewer is not fixed, and a user ID registered as a distributor ID at one time may be registered as a viewer ID at another time. The genre of the live-stream may be specified by the distributor when the distributor starts live-streaming, or may be automatically determined by a machine learning model in the server 10.

FIG. 6 is a data structure diagram showing an example of the user DB 318 of FIG. 4. The user DB 318 holds information regarding users. The user DB 318 stores a user ID that identifies a user, a distributor level that indicates the rating of the user as a distributor on the live-streaming platform, a fortune-telling level that indicates the user's level as a fortune-telling distributor, and the points that the user has, in association with each other. The point is the electronic value circulated within the live-streaming platform. When a distributor receives a gift from a viewer during a live-stream, the distributor's points increase by the value corresponding to the gift. The points are used, for example, to determine the amount of reward or money the distributor receives from the administrator of the live-streaming platform. Alternatively, when the distributor receives a gift from a viewer, the distributor may be given the amount of money corresponding to the gift instead of the points.

The fortune-telling level is an indicator of the level of the fortune-telling provided by the distributor on the live-streaming platform. The fortune-telling level may be evaluated and determined by the administrator based on reviews, user satisfaction, and comments about the fortune-telling distributor. Alternatively, the fortune-telling level may be automatically determined based on predetermined rules or a machine learning model.

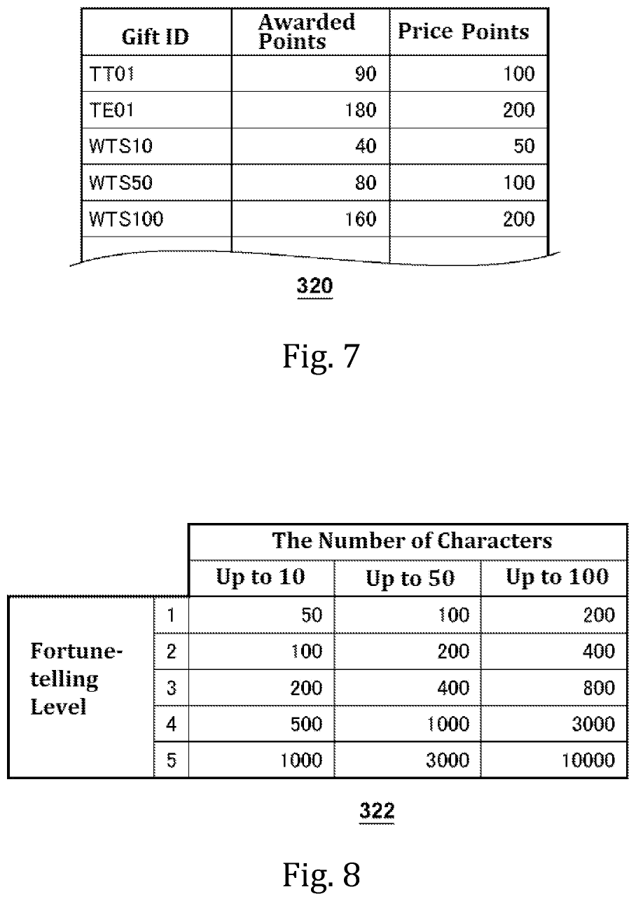

FIG. 7 is a data structure diagram showing an example of the gift DB 320 of FIG. 4. The gift DB 320 holds information regarding gifts available for the viewers in the live-streaming. A gift is electronic data with the following characteristics:
It can be purchased in exchange for the points or money, or can be given for free.
It can be given by a viewer to a distributor. Giving a gift to a distributor is also referred to as using the gift or throwing the gift.
Some gifts may be purchased and used at the same time, and some gifts may be purchased and then used at any time later by the purchaser viewer.
When a viewer gives a gift to a distributor, the distributor is awarded the amount of points corresponding to the gift.
When a gift is used, the use may trigger an effect associated with the gift. For example, an effect corresponding to the gift will appear on the live-streaming screen.

The gift DB 320 stores a gift ID for identifying a gift, awarded points, which is the amount of points awarded to a distributor when the gift is given to the distributor, and price points, which is the amount of points to be paid for use of the gift, in association with each other. A viewer is able to give a desired gift to a distributor by paying the price points of the desired gift when the viewer is viewing the live-stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

FIG. 8 is a data structure diagram showing an example of the price setting DB 322 in FIG. 4. The price setting DB 322 holds price settings for paid DMs. In the price setting DB 322, prices are set such that (1) the larger the maximum number of characters of a paid DM is, the higher the price to be paid is, and (2) the higher the fortune-telling level of the fortune-telling distributor is, the higher the price to be paid is. For example, FIG. 8 shows that 800 points must be paid when sending a paid DM with 100 of the character limit to a distributor whose fortune-telling level is “3”. At least some of the price paid by a viewer who send the paid DM is given to the fortune-telling distributor. The contents of the price setting DB 322 may be determined and inputted by the administrator. Alternatively, the price setting DB may be provided for each fortune-telling distributor, and each fortune-telling distributor may input and determine the contents of his/her own price setting DB.

Referring again to FIG. 4, Upon reception of a notification from the user terminal 20 on the distributor side to start a live-stream over the network NW, the distribution information providing unit 302 registers a stream ID for identifying this live-stream and the distributor ID of the distributor who performs the live-stream in the stream DB 314. When the distribution information providing unit 302 receives a request to provide information about live-streams from the viewing unit 200 of the user terminal 30 on the viewer side over the network NW, the distribution information providing unit 302 retrieves currently available live-streams from the stream DB 314 and makes a list of the available live-streams. The distribution information providing unit 302 refers to the user DB 318 for each fortune-telling live stream (live stream whose genre is fortune-telling) included in the generated list, and determines the fortune-telling level of the distributor of each fortune-telling live stream. The distribution information providing unit 302 adds the determined results, that is, the determined fortune-telling level for each fortune-telling live stream, to the list. The distribution information providing unit 302 transmits the generated list to the requesting user terminal 30 over the network NW. The viewer-side UI control unit 202 of the requesting user terminal 30 generates a live-stream selection screen based on the received list and displays it on the display of the user terminal 30.

Once the input information transmission unit 206 of the user terminal 30 received the viewer's selection result of the live-stream on the live-stream selection screen, the input information transmission unit 206 generates a distribution request including the stream ID of the selected live-stream, and transmits the request to the server 10 over the network NW. The distribution information providing unit 302 starts providing, to the requesting user terminal 30, the live-stream specified by the stream ID included in the received distribution request. The distribution information providing unit 302 updates the stream DB 314 to include the user ID of the viewer of the requesting user terminal 30 into the viewer IDs of the stream ID.

The relay unit 304 relays the video data from the distributor-side user terminal 20 to the viewer-side user terminal 30 in the live-streaming started by the distribution information providing unit 302. The relay unit 304 receives from the input information transmission unit 206 a signal that represents user input by a viewer during the live-stream or reproduction of the video data. The signal that represents user input may be an object specifying signal for specifying an object displayed on the display of the user terminal 30, and the object specifying signal includes the viewer ID of the viewer, the distributor ID of the distributor of the live-stream that the viewer watches, and an object ID that identifies the object. When the object is a gift, the object ID is the gift ID. Similarly, the relay unit 304 receives from the distribution unit 100 of the user terminal 20 a signal that represents user input performed by the distributor during reproduction of the video data, such as the object specifying signal. Alternatively, the signal that represents user input may be a comment input signal including a comment entered by a viewer to the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 308 updates the user DB 318 so as to increase the points of the distributor depending on the points of the gift identified by the gift ID included in the object specifying signal. Specifically, the gift processing unit 308 refers to the gift DB 320 to specify the points to be granted for the gift ID included in the received object specifying signal. The gift processing unit 308 then updates the user DB 318 to add the determined points to the points of the distributor ID included in the object specifying signal.

The payment processing unit 310 processes payment of a price of a gift by a viewer in response to reception of the object specifying signal. Specifically, the payment processing unit 310 refers to the gift DB 320 to specify the price points of the gift identified by the gift ID included in the object specifying signal. The payment processing unit 310 then updates the user DB 318 to subtract the specified price points from the points of the viewer identified by the viewer ID included in the object specifying signal.

The DM processing unit 312 performs processing related to a paid DM in conjunction with the DM reception unit 208 of the user terminals 20 and 30. Functions of the DM processing unit 312 will be described later.

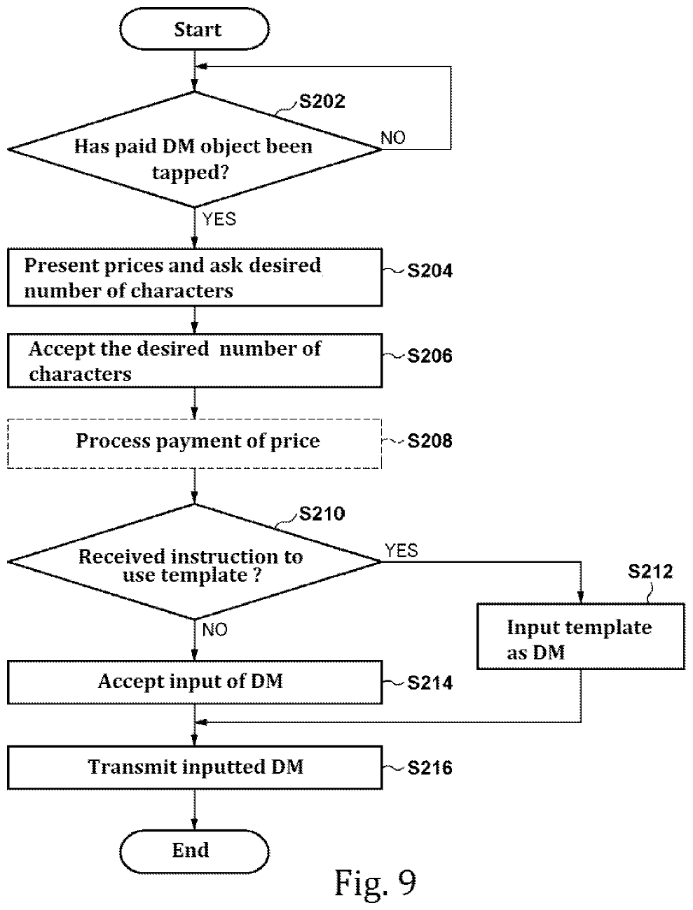

The operation of the live-streaming system 1 with the above configuration will be now described. FIG. 9 is a flowchart of a series of steps related to the use of a paid DM in the live streaming system 1. In FIG. 9, it is assumed that a predetermined viewer is viewing a fortune-telling live stream broadcast by a fortune-telling distributor on the user terminal 30 of the viewer. The DM reception unit 208 of the user terminal 30 waits until a paid DM object displayed on the live-streaming room screen is tapped (S202). Upon detection of tap on the paid DM object (Y in S202), the DM reception unit 208 shows a price for each maximum number of characters and asks the viewer about a desired maximum number of characters (S204). The DM reception unit 208 accepts the desired maximum number of characters from the viewer (S206). The DM reception unit 208 cooperates with the DM processing unit 312 of the server 10 to process payment of the price (S208). Before accepting input of a paid DM, the DM reception unit 208 asks the viewer whether to use a template for inputting (S210). For example, the DM reception unit 208 reads a list of available template texts from the template DB 150 and presents them to the viewer.

When an instruction to use a template is received from the viewer (Y of S210), the DM reception unit 208 inputs the specified template as the paid DM (S212). The process thereafter proceeds to step S216. When the viewer refuses to use the template in step S210, the DM reception unit 208 accepts input of the paid DM by the viewer (S214). The DM reception unit 208 transmits the inputted paid DM to the DM processing unit 312 of the server 10 over the network NW (S216). The DM processing unit 312 transmits the received paid DM only to the user terminal 20 of the fortune-telling distributor. The viewer-side UI control unit 202 in the user terminal 20 of the fortune-telling distributor displays the received paid DM on the display.

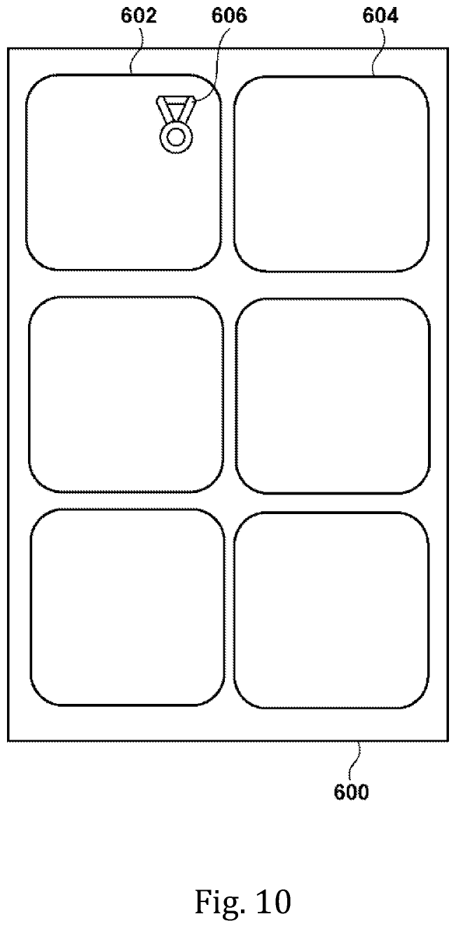

FIG. 10 is a representative screen image of the live-stream selection screen 600 displayed on the display of the viewer user terminal 30. The live-stream selection screen 600 includes thumbnails 602 and 604 indicating live-streams in the list of currently available live streams received from the server. The viewer-side UI control unit 202 generates the live-stream selection screen 600 based on the list of live-streams obtained from the server 10 and shows the screen on the display. The viewer-side UI control unit 202 adds a badge 606 corresponding to the fortune-telling level included in the list to the thumbnail 602 of the corresponding fortune-telling live stream. For example, in the embodiment, the fortune-telling level is set to one of five levels, 1, 2, 3, 4, and 5 from the lowest, and a badge corresponding to each level is prepared. By showing the badge in this way, the viewer is able to easily find a fortune-telling distributor with the level of fortune-telling that the viewer desires. In addition, the fortune-telling distributors can appeal the quality of his/her fortune-telling.

On the live-stream selection screen 600, thumbnails of fortune-telling live streams of high-level fortune-telling distributors are arranged at positions where they can be seen by viewers more easily than thumbnails of fortune-telling live streams of lower-level fortune-telling distributors, for example, at the top of the screen. As a result, on the live streaming platform, it is possible to promote the fortune-telling live streams of distributors who provide high-quality fortune-telling.

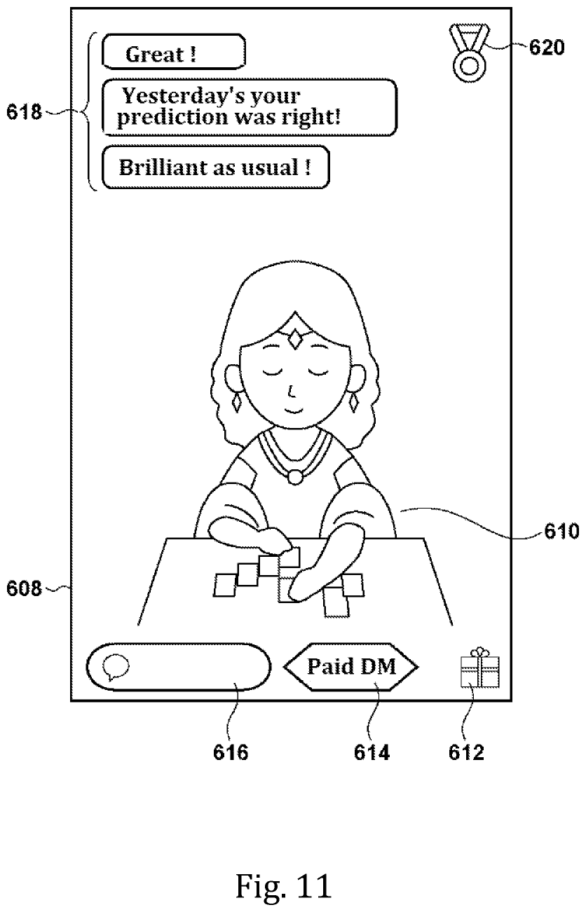

FIG. 11 is a representative screen image of a live-streaming room screen 608 shown on the display of the viewer user terminal 30. A live-streaming room screen 608 includes an image 610 of a fortune-telling distributor obtained by reproducing the video data received from the server 10, a gift object 612, a paid DM object 614, a comment input region 616, and a comment display region 618, and a badge 620.

Upon tapping the gift object 612 by the viewer, the superimposed information generation unit 204 generates a gift tab for receiving viewer's selection of the gift, and the viewer-side UI control unit 202 displays the generated gift tab on the live-streaming room screen 608.

The comment display region 618 may include a comment entered by the viewer and comments entered by other viewers. The superimposed information generation unit 204 generates a comment display region 618 including comments of other viewers received from the server 10, and the viewer-side UI control unit 202 includes the generated comment display region 618 in the live-streaming room screen 608.

The comment input region 616 accepts comment inputs by the viewer. The input information transmission unit 206 generates a comment input signal that includes the comment entered in the comment input region 616, and transmits the signal to the server 10 over the network NW. At the same time, the superimposed information generation unit 204 updates the comment display region 618 to display the comment entered in the comment input region 616.

The badge 620 corresponds to the badge 606 described above and indicates the level of the fortune-telling distributor on the live-streaming platform.

The viewer selects or taps the paid DM object 614 to have the fortune-telling distributor tell his/her fortune. Upon reception of the viewer's selection of the paid DM object 614, the DM reception unit 208 generates a price information request including the distributor ID of the fortune-telling distributor who is live-streaming the fortune-telling, and sends the request to the server 10 over the network NW. The DM processing unit 312 of the server 10 refers to the user DB 318 to specify the fortune-telling level corresponding to the distributor ID included in the received price information request. The DM processing unit 312 obtains price setting corresponding to the specified fortune-telling level from the price setting DB 322. The DM processing unit 312 transmits the obtained price setting to the requesting user terminal 30 over the network NW. The DM reception unit 208 of the user terminal 30 generates a character count inquiry region 622 based on the received price setting, and superimposes the generated character count inquiry region 622 on the live-streaming room screen 608.

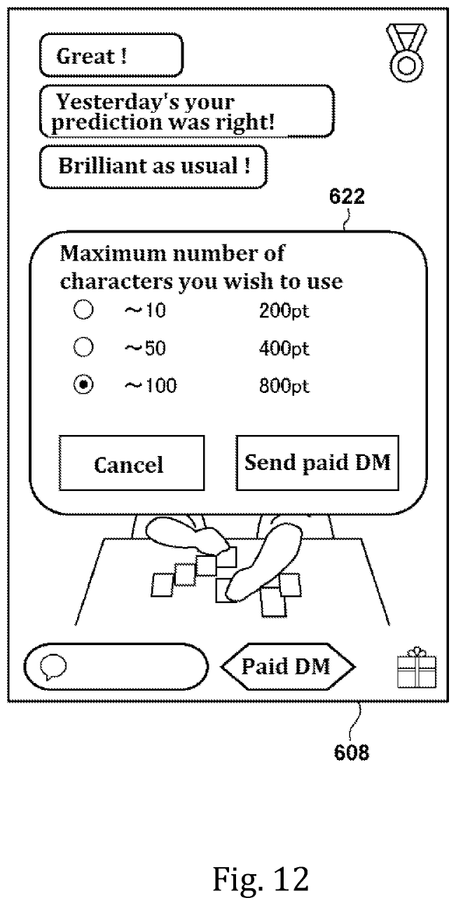

FIG. 12 is a representative screen image of the live-streaming room screen 608 on which a character count inquiry region is superimposed on the display of the viewer's user terminal 30. The character count inquiry region 622 is a region for presenting the price for each maximum number of characters and inquiring of the viewer about a desired maximum number of characters. The DM reception unit 208 includes sets of the maximum numbers of characters and the corresponding prices are included in the character count inquiry region 622 in a selectable form. In the character count inquiry region 622, the viewer selects, by a radio button, one of three options: “maximum number of characters=10, price=200 points”; “maximum number of characters=50, price=400 points”; and “maximum number of characters=100, price=800 points”. Once the viewer taps a “send paid DM” button in the character count inquiry region 622, the DM reception unit 208 accepts the maximum number of characters of the option selected by the radio button as the desired maximum number of characters. The DM reception unit 208 generates a DM settlement request that includes the distributor ID of the fortune-telling distributor, the viewer ID of the viewer, and the price corresponding to the option selected by the radio button. The DM reception unit 208 sends the generated settlement request to the server 10 over the network NW. The DM processing unit 312 of the server 10 updates the user DB 318 to subtract an amount equivalent to the price included in the received DM settlement request from the points of the viewer identified by the viewer ID included in the DM settlement request. At the same time, the DM processing unit 312 updates the user DB 318 to add points equivalent to the price included in the received DM settlement request to the points corresponding to the distributor ID included in the DM settlement request. The amount of points to be added may be the same as the price, or may be set to points obtained by multiplying the price by a predetermined coefficient, such as 0.9. When the settlement of the price is completed, the DM processing unit 312 generates a settlement completion response and transmits it to the requesting user terminal 30 over the network NW. Upon reception of the settlement completion response, the DM reception unit 208 of the user terminal 30 generates a template use inquiry region 624 and superimposes the generated template use inquiry region 624 on the live-streaming room screen 608.

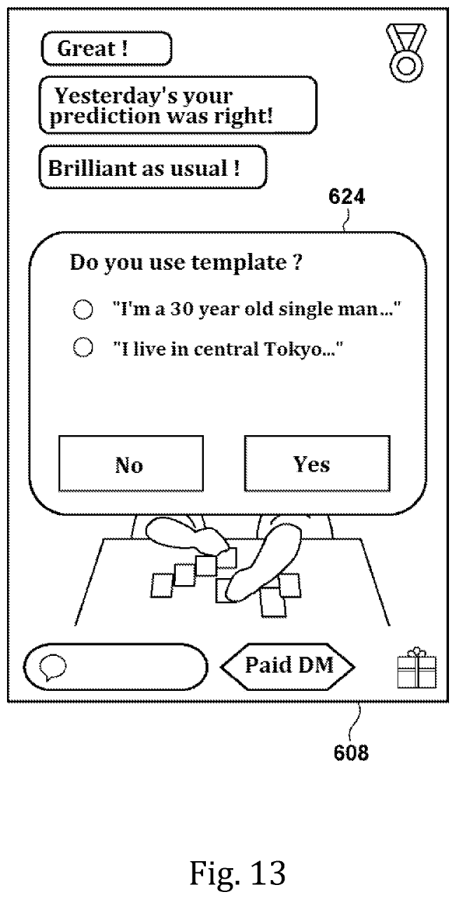

FIG. 13 is a representative screen image of the live-streaming room screen 608 on which the template use inquiry region is imposed on the display of the viewer's user terminal 30. The template usage inquiry region 624 is a region for inquiring of the viewer whether to use a template for message input before accepting the input of a paid DM. The DM reception unit 208 reads templates stored in the template DB 150 and includes read templates in the template usage inquiry region 624 in a selectable form. At this time, the DM reception unit 208 may not read templates exceeding the specified maximum number of characters, or may read up to the specified maximum number of characters (that is, the whole text will not be read out). In the template use inquiry region 624, the viewer selects a desired template from among the presented templates by using a radio button. When the viewer taps the “use” button in the template use inquiry region 624, the DM reception unit 208 accepts the template selected by the radio button as the desired template. The DM reception unit 208 generates a paid DM input accepting region 626 in which the received desired template is inputted in advance, and superimposes the generated paid DM input accepting region 626 on the live-streaming room screen 608.

Alternatively, the viewer who does not wish to use templates taps the “do not use” button in the template use inquiry region 624. When the tap on the button is detected, the DM reception unit 208 generates the paid DM accepting region 626 that has no prior input therein, and superimposes the generated paid DM input accepting region 626 on the live-streaming room screen 608.

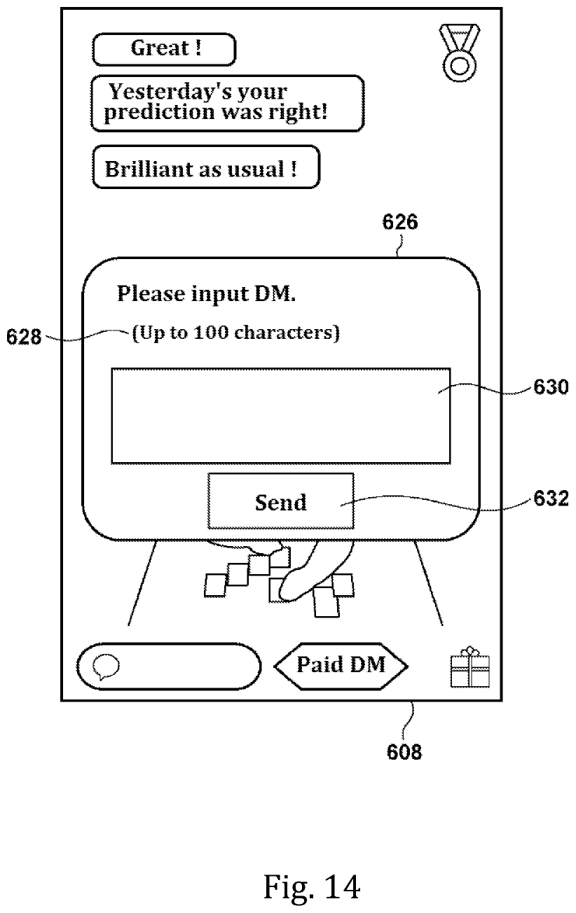

FIG. 14 is a representative screen image of the live-streaming room screen 608 on which the paid DM input accepting region 626 is superimposed on the display of the viewer's user terminal 30. The paid DM input accepting region 626 is a region for accepting input of a paid DM by a viewer. The paid DM input accepting region 626 has a maximum number of characters display region 628 that shows the maximum number of characters specified by the viewer as described with reference to FIG. 12, a text input region 630 that accepts text input, and a send button 632. When the use of the template has been instructed as described with reference FIG. 13, the DM reception unit 208 pre-enters the instructed template in the text input region 630. In the paid DM input accepting region 626, the viewer inputs desired text in the text input region 630 and then taps the send button 632. The DM reception unit 208 obtains the text entered in the text input region 630 upon detection of the tap on the send button 632. The DM reception unit 208 transmits the obtained text to the DM processing unit 312 of the server 10 over the network NW. The DM processing unit 312 transmits the received text only to the user terminal 20 of the fortune-telling distributor. The DM processing unit 312 does not transmit the text to the user terminals of other viewers who watch the fortune-telling live stream. Upon detection of the tap on the send button, the DM reception unit 208 generates a template registration region 634 and superimposes the generated template registration region 634 on the live-streaming room screen 608.

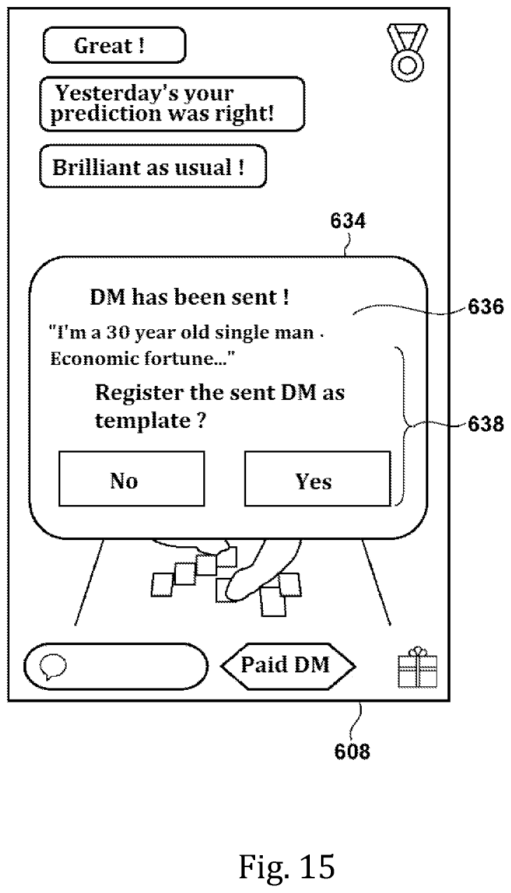

FIG. 15 is a representative screen image of a live streaming room screen on which the template registration region 634 is superimposed on the display of the viewer's user terminal 30. The template registration region 634 includes a sent DM display region 636 that shows the text of the paid DM that has been inputted and transmitted as described with reference to FIG. 14, and a template registration inquiry region 638 that is displayed when no use of templates has been selected as described with reference to FIG. 13. The viewer taps the “Yes” button in the template registration inquiry region 638 when he/she wishes to save the paid DM text that has been inputted and transmitted in FIG. 14 as a template used for the next time. When the template registration unit 210 detects the tap on the “Yes” button, the template registration unit 210 registers the text of the paid DM that has been transmitted as a template in the template DB 150.

In the above embodiment, an example of the holding unit includes a hard disk or semiconductor memory. It is understood by those skilled in the art that each element or component can be realized by a CPU not shown, a module of an installed application program, a module of a system program, or a semiconductor memory that temporarily stores the contents of data read from the hard disk, and the like.

The live-streaming system 1 of the embodiment provides a system that can safely pass personal information of a viewer to a fortune-telling distributor without being seen by other viewers of the fortune-telling distributor. This system can reduce concerns for fortune-telling on live-streaming, which may lead to wide spread of fortune-telling live streams. In addition, fortune-telling distributors are provided with a mechanism that allows them to directly receive rewards for their fortune-telling from their viewers. Therefore, the fortune-telling distributors can earn rewards for their fortune-telling more reliably and/or smoothly. Further, it is possible to complete both concealment of the message and payment of the price with one action, which enhances user convenience.

In addition, by charging the DMs to a distributor, it is possible to reduce chances of harassment to the distributor using the DMs can be reduced.

Further, the live-streaming system 1 of the embodiment introduces the fortune-telling level, and a price for fortune-telling is set according to the level. Thus, a mechanism is provided in which the fortune-telling skill is correctly evaluated and the evaluation is returned in the form of a reward. This makes it possible to realize a live-streaming platform attractive to fortune-telling distributors with high fortune-telling skills.

In addition, in the live-streaming system 1 of the embodiment, by creating a place where “the skill as a fortune teller” is evaluated, it is possible to foster a fortune-telling culture among distributors and viewers.

Moreover, the live-streaming system 1 of the embodiment allows to use a pre-created template when inputting a paid DM. Thus, it is possible to quickly input a relatively long text of the paid DM during the live-stream, which usually requires participants to respond in real time. As a result, viewers can request fortune-telling through paid DMs without interrupting the flow of fortune-telling live-stream.

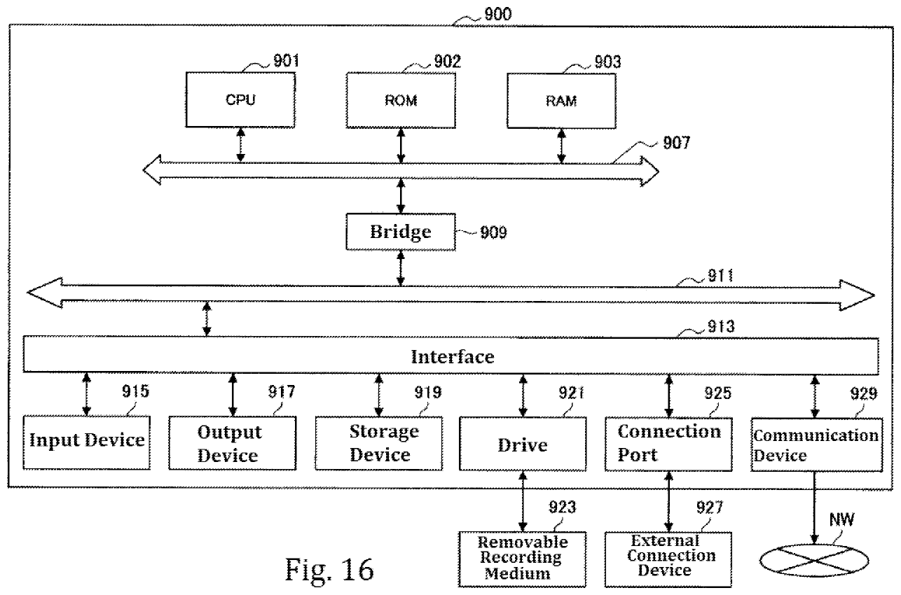

Referring to FIG. 16, the hardware configuration of the information processing device will be now described. FIG. 16 is a block diagram showing an example of a hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in the embodiment. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live-streaming system 1 in the embodiment have been described. This embodiment is a merely example, and it is understood by those skilled in the art that various modifications are possible for each component and a combination of each process, and that such modifications are also within the scope of the present disclosure.

The embodiment has been described based on the case in which the paid DM is set as exclusive information that cannot be accessed or viewed by other viewers, but it is not limited to this. For example, in addition to normal comments, secret comments that are not displayed to anyone other than the sender viewer and the distributor may be provided, and the secret comments may be entered for a fee.

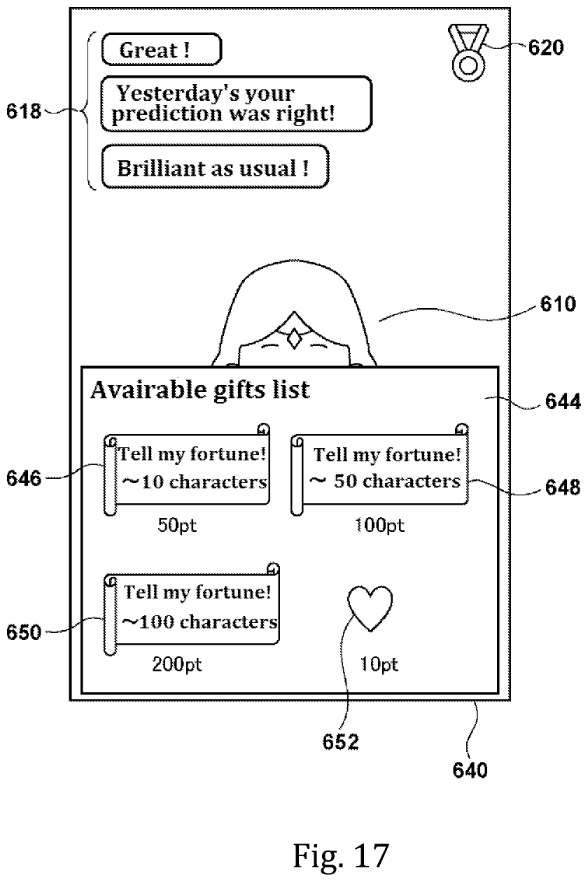

FIG. 17 is a representative screen image of a live-streaming room screen 640 of a modification example displayed on the display of the viewer's user terminal 30. The live-streaming room screen 640 includes an image 610 of a fortune-telling distributor obtained by reproducing the video data received from the server 10, a gift tub 644 for accepting gift selection, a comment display region 618, and a badge 620. The live-streaming room screen 640 of FIG. 17 corresponds to a screen shown after a tap on the gift object 612 in the live-streaming room screen 608 of FIG. 17 is detected.

In the modification example, upon detection of tap on the gift object in the live-streaming room screen, the user terminal 30 generates a gift information request that includes the stream ID of the live-stream, and transmits the request to the server 10 over the network NW. Upon receipt of the gift information request, the server 10 refers to the gift DB 320 and specifies the gift IDs of available gifts. At this time, the server 10 refers to the stream DB 314 to determine a genre to which the live-stream with the stream ID included in the received gift information request belongs.

The gift DB 320 of this modification example has gift IDs of ordinary gifts that can be used in live-streams of any genre (for example, “TT01” and “TE01” in FIG. 7), and gift IDs of special gifts that can be used only in live-streams of a specific genre(s) (for example, “WTS10”, “WTS50”, and “WTS100” in FIG. 7). In this example, the specific genre is fortune-telling, and the special gift is a secret comment gift that enables transmission of secret comments.

The server 10 specifies the secret comment gift as the available gift when the determined genre is fortune-telling, and does not specify the secret comment gift as the available gift when the determined genre is not fortune-telling. The server 10 generates gift information that includes the specified gift ID, and transmits it to the user terminal 30 of the requester. The user terminal 30 displays on the gift tab 644 the gift object of the gift specified by the gift ID included in the gift information.

In FIG. 17, the gift tab 644 contains three secret comment gift objects 646, 648 and 650 and a normal gift object 652 corresponding to the normal gift. The secret comment gift object 646 corresponds to the secret comment gift identified by the gift ID “WTS10” of FIG. 7. The gift is a gift that enables the user to obtain the right to transmit a secret comment having up to 10 characters to the fortune-telling distributor by paying 50 points. The same is applied to the other secret comment gift objects 648 and 650.

Once the viewer taps the secret comment gift object that has the desired maximum number of characters on the live-streaming room screen 640 of FIG. 17, the similar processes to the price payment process, the template usage inquiry process, and the exclusive information input/transmission process described above are executed. And the secret comment that can be only seen by the sender viewer and the distributor is displayed on the user terminal 20 of the distributor and the user terminal 30 of the sender viewer. In particular, the server 10 transmits the secret comment to the user terminal 20 of the fortune-telling distributor and does not transmit the secret comment to the user terminals of other viewers.

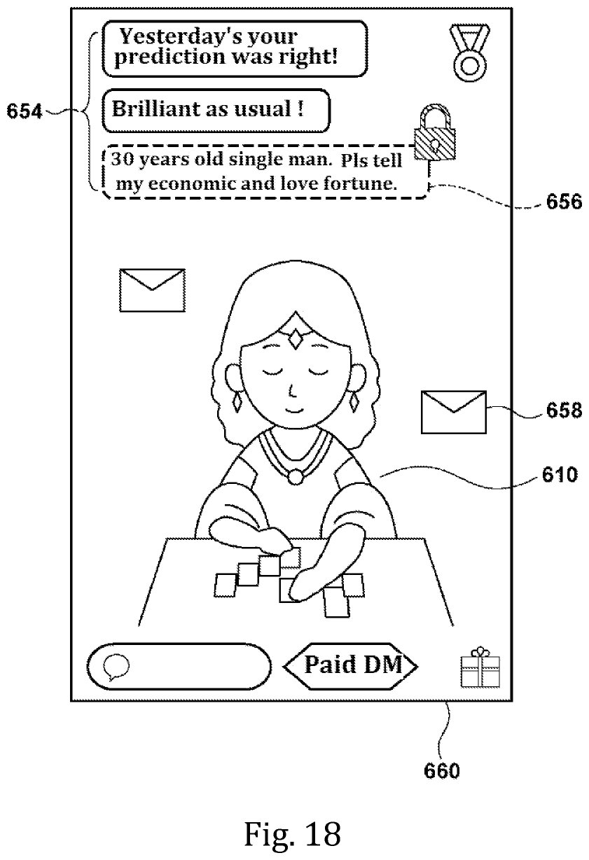

FIG. 18 is a representative screen image of a live-streaming room screen 660 displayed on the display of the user terminal 30 of the viewer who sent the secret comment. The live-streaming room screen 660 has an image 610 of the fortune-telling distributor, a comment display region 654 updated from the state of FIG. 17, and an effect 658 corresponding to a secret comment gift. The user terminal 30 updates the comment display region 654 to display a secret comment 656 when the secret comment gift is used and the secret comment is inputted and transmitted. The secret comments 656 are displayed in a manner different from normal comments. In the example of FIG. 18, normal comments are framed in solid lines, while the secret comment 656 is framed in a dashed line and marked with a key indicating that it is the secret comment. Also, when the secret comment gift is used, the user terminal 30 shows the effect 658 corresponding to the gift in the live-streaming room screen 660 during the fortune-telling live-stream. This effect 658 is also shown on the display of the user terminal 20 of the distributor. This effect 658 may or may not be shown on the displays of other viewers' user terminals. When it is shown, other viewers are able to know that the secret comment has been sent, but unable to know the content of the secret comment.

In the above example, the administrator determines the price of the secret comment gift and registers it in the gift DB 320. In another example, the price may be dynamically set depending on the fortune-telling level of the fortune-telling distributor in the same manner as the above embodiment.

In the embodiment, the case where the price is set depending on the fortune-telling level has been described. However, the disclosure is not limited to this, and the price may be depending on any other indicators, for example, the distributor level.

In the embodiment, the case where the price is set depending on the fortune-telling level and the maximum number of characters. However, the price may be set depending on the maximum number of characters without depending on the fortune-telling level, or the price may be set depending on the fortune-telling level without depending on the maximum number of characters, or the price may be set as a fixed value.

In the embodiment, the case where a viewer creates and saves a template in advance. However, the disclosure is not limited to this. For example, the user terminal 30 may automatically create a template from the viewer's profile information. Alternatively, the profile information may be configured to be selectable as a template. Alternatively, the user terminal 30 may present at least one question set by the administrator to the viewer, and transmit the viewer's answer to the question as it is to the server 10 as the paid DM or a text for pre-filling the paid DM may be automatically created from the viewer's answer. Alternatively, the at least one question may be individually configurable by the fortune-telling distributor.

In the embodiment, the case where the viewer pays a price and transmits the exclusive information in fortune-telling live-stream, but the disclosure is not limited to this. The technical idea of the disclosure may also be applied to services where there is value in delivering, only to the intended distributor, information that is not desired to be shown to others.

In the embodiment, the case where the viewer's input of the exclusive information (paid DM) that is not viewable by other viewers is accepted during the live-stream on condition that the viewer pays a price. However, the disclosure is not limited to this. Alternatively, input of exclusive information may be accepted in advance, for example, and the exclusive information may be transmitted to the server on condition that the payment is made. Alternatively, the input of the exclusive information may be accepted first, the inputted exclusive information may be then transmitted to the server, and the server may transmit the exclusive information to the user terminal of the distributor on condition that the payment is made. In either case, the exclusive information is information that cannot be accessed or viewed by viewers other than the viewer who inputted it and that is transmitted to the terminal of the distributor on condition that the viewer pays its price.

When the input of the exclusive information is accepted first, a pay-per-use payment system may be adopted. For example, the user terminal 30 accepts the viewer's input of the paid DM text. The user terminal 30 calculates a price of the inputted text using a predetermined rate (for example, 1 point per character). The user terminal 30 presents the calculated price to the viewer and inquires of the viewer whether to agree to pay the price. Upon acceptance of a viewer's consent to payment of the price, the user terminal 30 transmits the inputted text to the server 10. The predetermined rate may be a rate that depends on the fortune-telling level of the fortune-telling distributor, and for example, a higher rate may be set for the higher fortune-telling level. In this case, the viewer can enter text of the paid DM without worrying about the number of characters.

In the embodiment, the case where tap on the paid DM object 614 enables input of a paid DM, but the disclosure is not limited to this. For example, when the user terminal 30 detects a leftward or rightward flick/swipe on the live-streaming room screen, the user terminal 30 may cause the live-streaming room screen to turn to a dark mode. The user terminal 30 processes comments received on the dark-mode live-streaming room screen as the secret comments.

In the embodiment, the case where the input of the paid DM is enabled after completing the payment process by the viewer in the server 10. However, the disclosure is not limited to this. Alternatively, the input of the paid DM may be enabled after the viewer's consent to payment of the price is received. In this case, the actual payment process may be performed in parallel with the input or transmission of the paid DM, or thereafter.

The conversion rate from the points paid for the gift to the points awarded in the embodiment is merely example, and the conversion rate may be appropriately set by the administrator of the live-streaming system 1, for example.

The technical idea according to the embodiment may be applied to live commerce or virtual live-streaming using an avatar that moves in synchronization with the movement of the distributor instead of the image of the distributor.

The procedures described herein, particularly those described with a flow diagram, a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10. For example, the superimposition of a predetermined frame image on an image of the video data performed by the user terminal where the video data is reproduced may be performed by the server 10 or may be performed by the user terminal where the video data is generated.

What is claimed is:

1. A computer-readable tangible non-transitory storage medium storing a program for causing a terminal of a viewer to:
receive, from a server over a network, a video data related to a live-stream in which a distributor, the viewer, and other viewers participate;
accept input of normal information by the viewer during the live-stream, the normal information being viewable by the distributor and the other viewers; and
accept input of exclusive information by the viewer during the live-stream, the exclusive information being information that is transmitted to a terminal of the distributor on condition that the viewer pays or consents to pay a price and that is not viewable by the other viewers.

2. The computer-readable tangible non-transitory storage medium of claim 1, wherein the price is set such that the larger a maximum number of characters in the exclusive information is, the higher the price is.

3. The computer-readable tangible non-transitory storage medium of claim 1, wherein the price is set to correspond to a level of the distributor on a live-streaming platform.

4. The computer-readable tangible non-transitory storage medium of claim 1, wherein at least some of the price paid by the viewer is given to the distributor.

5. The computer-readable tangible non-transitory storage medium of claim 1, wherein the program further causing the terminal of the viewer to:
register pre-inputted exclusive information to a holding unit,
wherein the accepting the input of the exclusive information includes reading out the exclusive information stored in the holding unit.

6. The computer-readable tangible non-transitory storage medium of claim 1, wherein the program further causing the terminal of the viewer to:
show an effect corresponding to inputted exclusive information on a display during the live-stream,
wherein the effect is also shown on displays of terminals of the other viewers.

7. The computer-readable tangible non-transitory storage medium of claim 1, wherein the live stream is a live-stream of a fortune-telling genre.

8. A terminal, comprising:
a reception unit receiving, from a server over a network, a video data related to a live-stream in which a distributor, the viewer, and other viewers participate;
an accepting unit accepting input of normal information by the viewer during the live-stream, the normal information being viewable by the distributor and the other viewers; and
an accepting unit accepting input of exclusive information by the viewer during the live-stream, the exclusive information being information that is transmitted to a terminal of the distributor on condition that the viewer pays or consents to pay a price and that is not viewable by the other viewers.

9. The terminal of claim 8, wherein the price is set such that the larger a maximum number of characters in the exclusive information is, the higher the price is.

10. The terminal of claim 8, wherein the price is set to correspond to a level of the distributor on a live-streaming platform.

11. The terminal of claim 8, wherein at least some of the price paid by the viewer is given to the distributor.

12. The terminal of claim 8, further comprising:
a holding unit in which pre-inputted exclusive information is registered,
wherein the accepting the input of the exclusive information includes reading out the exclusive information stored in the holding unit.

13. The terminal of claim 8, wherein the terminal shows an effect corresponding to inputted exclusive information on a display during the live-stream,
wherein the effect is also shown on displays of terminals of the other viewers.

14. The terminal of claim 8, wherein the live stream is a live-stream of a fortune-telling genre.

15. A server, comprising:
a relay unit relaying video data from a terminal of a distributor to a terminal of a viewer, the video data being related to a live-stream in which the distributor, the viewer, and other viewers participate;
a reception unit receiving normal information inputted by the viewer from a terminal of the viewer during the live-stream;
a transmission unit transmitting the received normal information to a terminal of the distributor and terminals of the other viewers; and
a transmission unit transmitting exclusive information inputted by the viewer to the terminal of the distributor when the viewer pays or consents to pay a price, the exclusive information being not transmitted to the terminals of the other viewers.
